(19) United States
(12) Patent Application Publication
(10) Pub. No.: US 2013/0324148 A1
(43) Pub. Date: Dec. 5, 2013

(54) PRODUCT POSITION TRACKING SYSTEM

(71) Applicants: Andrew F. Geib, Glastonbury, CT (US); Dale R. Masslon, Tolland, CT (US); Paul Raymond Scheid, West Hartford, CT (US)

(72) Inventors: Andrew F. Geib, Glastonbury, CT (US); Dale R. Masslon, Tolland, CT (US); Paul Raymond Scheid, West Hartford, CT (US)

(73) Assignee: UNITED TECHNOLOGIES CORPORATION, Hartford, CT (US)

(21) Appl. No.: 13/485,614

(22) Filed: May 31, 2012

(51) Int. Cl. H04Q 5/22; H04W 4/02

(52) U.S. Cl. 455/456.1; 340/10.1

(57) ABSTRACT

An engine frame comprises an engine support structure and a communication device with a serial number and a wireless transceiver. The engine support structure is configured to support an engine for maintenance or transport. The communication device is configured to determine a location of the engine frame, and broadcast a report message including the location of the engine frame and the serial number to a remote server via the wireless transceiver.

### BACKGROUND

The present invention relates generally to position tracking, and more particularly to a centralized system for tracking engine frames and engines mounted on those engine frames.

Engine frames are commonly used to support aircraft engines during transportation and maintenance. Engine frames are typically comprised of a rigid support structure such as a steel frame with support and attachment points for engine components. Some engine frames are wheeled carts, while others are stationary stands. Conventional engine frames are solid structures incorporating no electronics or communication devices.

Facilities that service many aircraft, such as large airports or heavy maintenance shops, may have many engine frames distributed across a wide area. At some facilities, engine frames are tracked using spreadsheets or lists which are manually updated by workers whenever an engine frame is moved or assigned to a location or project. This system is prone to human error and delay. Engine frames can sometimes be misplaced or mis-assigned, and delays in reporting movement or reassignment of engine frames are commonplace.

### SUMMARY

The present invention is directed toward an engine frame comprising an engine support structure and a communication device with a serial number and a wireless transceiver. The engine support structure is configured to support an engine for maintenance or transport. The communication device is configured to determine a location of the engine frame, and broadcast a report message including the location of the engine frame and the serial number to a remote server via the wireless transceiver.

### BRIEF DESCRIPTION OF THE DRAWINGS

FIG. 1 is a perspective view of an engine frame carrying an aircraft engine.

FIG. 2 is a schematic block diagram of a communication device in the engine frame of FIG. 1.

FIG. 3 is a schematic block diagram of a tracking system including the engine frame and aircraft engine of FIG. 1.

### DETAILED DESCRIPTION

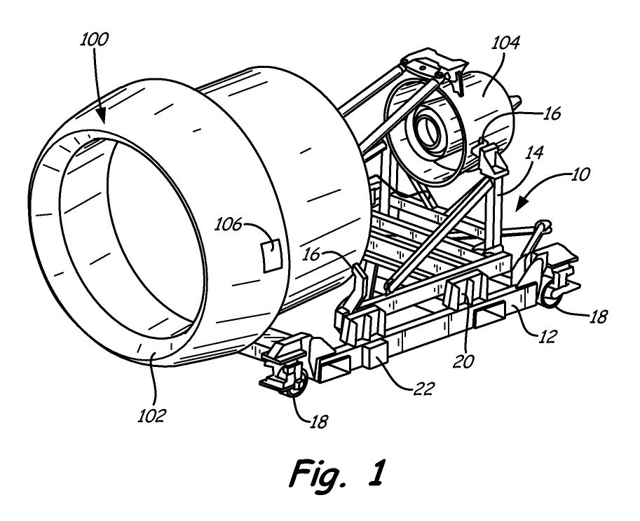

FIG. 1 is a perspective view of engine frame 10 carrying aircraft engine 100. Engine frame 10 is a support frame for transport and/or maintenance of aircraft engines such as aircraft engine 100, which is depicted in a partially disassembled state. Engine frame 10 comprises base frame 12, support frame 14, attachment points 16, wheels 18, frame connection 20, and communication device 22. Aircraft engine 100 is a gas turbine engine shown partially disassembled, with fore portion 102, aft portion 104, and RFID plate 106. Fore portion 102 includes inlet and compressor sections of aircraft engine 100, while aft portion 104 includes turbine and nozzle sections of aircraft engine 100. Some components of aircraft engine 10 are omitted from FIG. 1 to provide a less obstructed view of engine frame 10. These omitted components include a gas turbine engine burner section.

Base frame 12 is a rigid weight-bearing frame such as a box or ladder frame which retains support frame 14, and thereby aircraft engine 100. Support frame 14 is a rigid support structure comprised of a plurality of braced arms configured to retain and support aircraft engine 100. Support frame 14 may, in some embodiments, be specific to a particular range of sizes and shapes of aircraft engine 100. Base frame 12 and support frame 14 may, for instance, be formed of steel beams, tubes, or posts. Support frame 14 contacts aircraft engine 100 at attachment points 16, which may include support platforms, bolt points, clamps, and other means for securing each section of aircraft engine 100 to support frame 14. In some embodiments, attachment points 16 may include at least one electromagnetic or mechanical switch actuated by the attachment of aircraft engine 100 to engine frame 10, or by proximity of aircraft engine 100 to engine frame 10, as described in greater detail below. This electromagnetic or mechanical switch may alternatively be affixed to other locations on engine frame 10, including elsewhere on support frame 16.

Wheels 18 are load-bearing wheels attached to base frame 12 for transit of engine frame 10 and transport of aircraft engine 100. Wheels 18 may be equipped with wheel locks or clamps to prevent movement of engine frame 10, when so desired. Not all embodiments of aircraft frame 10 need include wheels 18. Support frame 14 and base frame 12 are secured together via frame connection 20, which may be a weld, a screw or bolt connection, or any other appropriate attachment mechanism. In other embodiments, support frame 14 and base frame 12 may comprise a single unitary piece, obviating the need for frame connection 20 as a separate component.

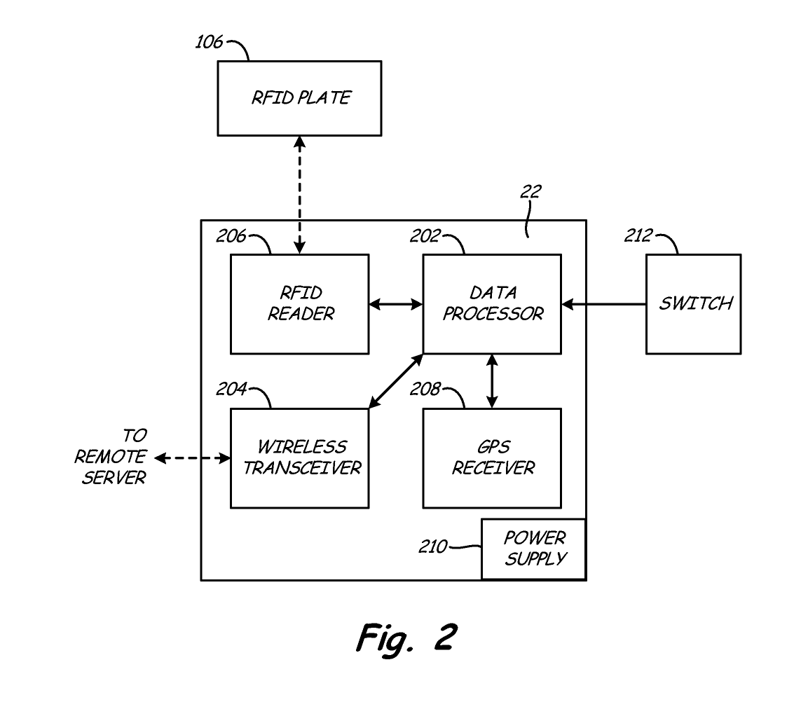

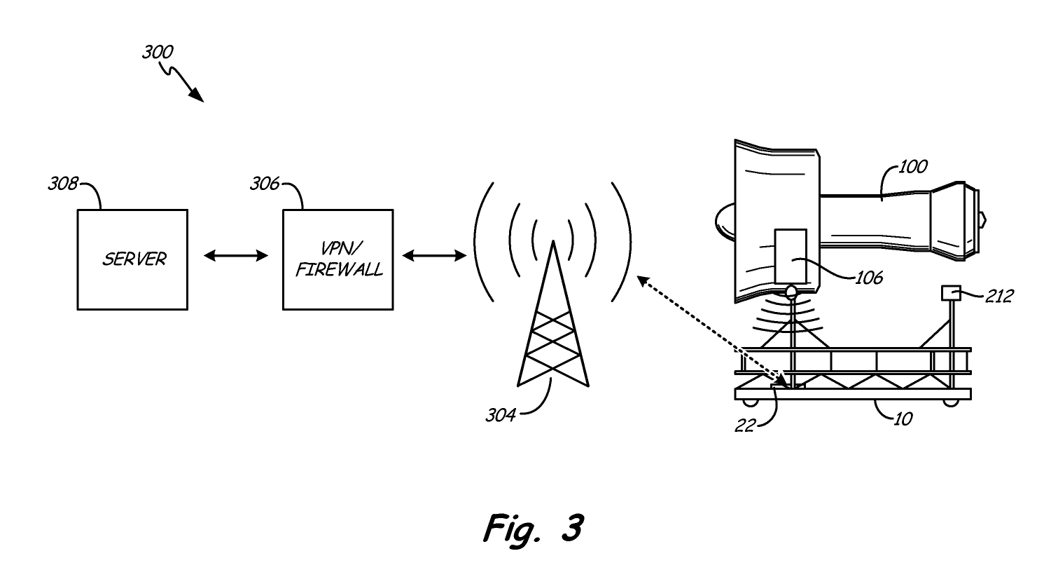

Communication device 22 is a wireless computing device for locating engine frame 10 and aircraft engine 100. Communication device 22 is depicted as attached to base frame 12, but may be mounted anywhere on engine frame 10, including in protected locations or in a closed receptacle to avoid damage during transit of engine frame 10. Communication device 22 communicates with a wireless network to determine and transmit a location of engine frame 10 to a remote digital database, as described in greater detail with respect to FIG. 3. Communication device 22 may, for instance, be a cellular device. Communication device 22 may also include an RFID reader and/or a GPS receiver, as described below with respect to FIG. 2. Communication device 22 may, for instance, determine the location of engine frame 10 through this attached GPS receiver, or by cellular triangulation. Embodiments of communication device 22 which include an RFID reader may query RFID plate 106 of aircraft engine 100, as explained below, for information about aircraft engine 100. This information is broadcast together with position information to the aforementioned digital database.

FIG. 2 depicts communication device 22, comprising data processor 202, wireless transceiver 204, RFID reader 306, GPS receiver 208, and power supply 210. FIG. 2 further depicts switch 212 and RFID plate 106.

Data processor 202 is a logic capable device such as a microprocessor. Data processor 22 may be hardwired to perform a limited set of functions, or a programmable device programmably configured to perform these functions. Wireless transceiver 204 is a cellular, Wi-Fi, or other wireless transceiver configured to communicate with a remote server via a wireless network, as described below with respect to FIG. 3. In some embodiments, wireless transceiver 204 may be a cellular card. In other embodiments, wireless transceiver 204 may be a powered RFID transponder readable at medium range (e.g. a 100+ yards). RFID reader 306 is an RFID device configured to receive RFID signals from RFID plate 106. In some embodiments, RFID reader 306 may further be capable of inductively powering RFID plate 106. GPS receiver 208 is a GPS device capable of ascertaining a location of communication device 22 (and thereby engine frame 10 and any attached engine) from GPS satellites. Power source 210 may be a rechargeable or replaceable battery or similar power cell configured to power comprising data processor 202, wireless transceiver 204, RFID reader 306, and GPS receiver 208. Non-mobile embodiments of engine frame 10 may additionally or alternatively utilize utility grid power for power source 210.

RFID plate 106 is an RFID device attached to aircraft engine 100, and configured to provide information about aircraft engine 100 when queried by an appropriate device, such as communication device 22. Information stored and provided by RFID plate 106 may, for instance, include an engine serial number, model number, and manufacturer ID. In some embodiments, RFID plate 106 may be a passive device inductively powered by communication device 22. Switch 212 is a mechanical or electromagnetic switch connected to communication device 22, and actuated by the presence of aircraft engine 100 on or near support frame 10.

RFID reader 206 may energize RFID plate 106 periodically or continually, and query RFID plate 106 periodically. Alternatively, RFID reader 206 may energize RFID plate 106 only in response to requests from server 308 for engine information, or more generally for a report message. In some embodiments, communication device 22 may energize and query RFID plate 106 only while a state of switch 212 indicates that aircraft engine 100 is present on engine frame 10, so as to conserver power. Switch 212 may be a mechanical switch actuated by physical contact with aircraft engine 100, such as a weight sensor or mechanically depressed button. Alternatively, switch 212 may be an electromagnetic switch without moving parts, actuated by proximity to a large ferromagnetic mass.

Data processor 202 is configured to determine position of engine frame 10 using wireless transceiver 204 as described below with respect to FIG. 3, or using GPS receiver 208. Data processor 202 then transmits a report message to a remote server via wireless transceiver 204. This report message contains both the ascertained position and a serial number which uniquely identifies engine frame 10. The report message may further comprise a switch bit reflecting a state of switch 212, and thereby indicating whether an engine is currently supported on engine frame 10. In some embodiments, the report message may also contain some or all engine information stored on RFID plate 106, so long as an engine is mounted on engine frame 10.

FIG. 3 depicts position tracking system 300, comprising engine frame 10, communication device 22, aircraft engine 100, switch 212, RFID reader 106, network 304, VPN/firewall device 306, and server 308.

As discussed above with respect to FIG. 1, engine frame 10 is a support frame for aircraft engine 100. As discussed above with respect to FIG. 2, communication device 22 is a wireless computing device comprising data processor 202, wireless transceiver 204, RFID reader 306, and GPS receiver 208. Communication device 22 communicates with server 308 via VPN/firewall device 306 and network 304. In the embodiment shown in FIG. 3, network 304 is a wireless network, while VPN/firewall device 306 is a virtual network that includes server 308.

Communication device 22 has a unique serial number associated with engine frame 10, and communicates wirelessly with network 304. Network 304 may, for instance, be a public cellular phone network comprised of a plurality of distributed cellular towers. Alternatively, network 304 may be a medium area hardware network such as a facility-wide airport or maintenance location network. In one embodiment, communication device 22 ascertains its position from network 304 by means of triangulation, e.g. by triangulating signals from known locations of cellular towers or wireless routers. In another embodiment, communication device 22 ascertains its position via GPS signals received by GPS receiver 208, as described above with respect to FIG. 2. In a third embodiment, communication device 22 estimates the location of engine frame 10 based on the known location of the single nearest (or strongest-signal) hub or router of network 304. Communication device 22 transmits this location information together with its unique serial number in a report message that is sent to server 308 via VPN/firewall device 306 and network 304.

VPN/firewall device 306 is a VPN server/firewall device which provides a protected local network connection to server 308 over network 304, particularly where network 304 is a public utility network. Although VPN/firewall device 306 is shown connected only to network 304 and server 308, VPN/firewall device 306 may act as a gateway between network 304 and a plurality of devices on a shared local network, including data backup devices and user terminals configured to access server 308. Server 308 is a hardware or software server which hosts a database referencing engine frames by serial number to engine frame locations. In some embodiments, this database may also store engine information for engines mounted on engine frames indexed by server 308, as described in further detail below.

As described above with respect to FIG. 2, RFID plate 106 is an RFID device programmed with, e.g., the serial number, manufacturer, and model number of aircraft engine 100. RFID plate 106 may be programmed with other engine information, as desired. RFID plate 106 may be an unpowered, passive device, or a device powered with an integral battery or similar energy source. RFID plate 106 provides programmed information (serial number, manufacturer, model number) to communication device 22 when queried. When RFID plate is energized (see discussion above with respect to FIG. 2), communication device 22 is configured to receive this programmed information via RFID reader 206.

Communication device 22 transmits report messages to server 308 via network 304 and VPN/firewall device 306. These report messages contain position information and a serial number from communication device 22 that uniquely identifies engine frame 10. Report messages may further include a switch bit corresponding to a state of switch 212, and indicating whether engine frame 10 is currently in use (i.e. currently hosts an aircraft engine). If aircraft engine 100 is mounted on engine frame 10, the report messages may further comprise queried information from RFID plate 106, such as an engine serial number, model number, or manufacturer. Communication device 22 may make periodic or scheduled reports to server 308 over network 304, or may report location and other information only when queried by server 308.

Server 308 may be accessed locally or remotely (e.g. over network 304) by users or automated systems to query server 308 for a variety of database information. Server 308 can, for instance, handle requests for the location of a particular engine frame by serial number. Server 308 can provide the use state of a particular engine frame by serial number (i.e. whether the engine frame currently hosts an aircraft engine), or the engine information of any RFID-equipped engine located on the specified engine frame. Server 308 can identify the nearest engine frame to a specified location, such as a user or aircraft location. This query may be narrowed to specify an engine frame not currently in use for another engine. Server 308 can provide the number of in-use and not-in-use engine frames within a specified area, and can provide the location of an engine with specified engine information (e.g. serial number, model number, or manufacturer), if that engine is supported on engine frame 10. All of these queries may be addressed from any location with access to server 308, including both on-site at airports or maintenance locations, and remotely for bookkeeping or management at another location. Position tracking system 300 centrally collects a variety of information about the locations of engines and engine frames either periodically, or in real time in response to user queries. Thus, any user with access to server 308 can use position tracking system 300 to access a range of up- to-date engine and engine-frame location for maintenance and transport of engines, without opportunity for human error or delay.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An engine frame comprising:
an engine support structure configured to support an engine for maintenance or transport;
a communication device with a wireless transceiver and a engine frame serial number, and configured to:
determine a location of the engine frame; and
broadcast a report message including the location of the engine frame and the serial number to a remote server via the wireless transceiver.

2. The engine frame of claim 1, wherein the wireless transceiver is a cellular transceiver.

3. The engine frame of claim 2, wherein determining a location of the engine frame comprises identifying a location by means of cellular triangulation using the cellular transceiver.

4. The engine frame of claim 1, wherein the engine frame further comprises a GPS receiver, and wherein determining a location of the engine frame comprises retrieving a location from the GPS receiver.

5. The engine frame of claim 1, further comprising an RFID reader configured to energize and query an RFID device on an engine supported on the engine support structure.

6. The engine frame of claim 5, wherein the RFID reader is configured to retrieve an engine serial number from the RFID device.

7. The engine frame of claim 6, wherein the report message further comprises the engine serial number.

8. The engine frame of claim 1, wherein the engine support structure further comprises a switch actuated by presence of an engine supported on the engine support structure.

9. The engine frame of claim 8, wherein the report message further comprises a switch bit indicating a state of the switch.

10. The engine frame of claim 8, wherein the switch is an electromagnetic switch actuated by proximity to a large ferromagnetic mass.

11. The engine frame of claim 8, wherein the switch is a mechanical switch actuated by physical contact with the engine.

12. The engine frame of claim 8, further comprising an RFID reader configured to energize and query an RFID device on the engine when the switch indicates that the engine is present.

13. The engine frame of claim 12, wherein the RFID reader is configured to retrieve engine serial number, engine model number, or engine manufacturer from the RFID device, and wherein the engine serial number, engine model number, or engine manufacturer are included in the report message.

14. The engine frame of claim 1, wherein the remote server is a database server accessible to local and remote users, and which indexes engine frame location by engine frame serial number.

15. The engine frame of claim 14, wherein the remote server further indexes an engine switch bit indicating whether the engine frame is in use.

16. The engine frame of claim 14, wherein the remote server further indexes engine information corresponding to engines mounted on the engine frame.

17. The engine frame of claim 14, wherein the engine information includes an engine serial number, an engine model number, or an engine manufacturer.

18. The engine frame of claim 1, wherein the engine support structure is configured to receive an aircraft engine.

19. The engine frame of claim 1, wherein the engine support structure includes at least one attachment point configured to anchor the engine.

20. The engine frame of claim 1, wherein the wireless transceiver is a powered RFID transponder.
